(19) United States
(12) Patent Application Publication
(10) Pub. No.: US 2012/0106511 A1
(43) Pub. Date: May 3, 2012

(54) Method of Handling Primary Serving Cell Change

(76) Inventor: Chih-Hsiang Wu, Taoyuan County (TW)

(21) Appl. No.: 13/287,130

(22) Filed: Nov. 2, 2011

Related U.S. Application Data
(60) Provisional application No. 61/409,637, filed on Nov. 3, 2010.
(60) Provisional application No. 61/409,983, filed on Nov. 4, 2010.

(51) Int. Cl. H04W 36/32

(52) U.S. Cl. 370/331

(57) ABSTRACT

A method of handling primary serving cell change for a network in a wireless communication system is disclosed. The method comprises configuring a first cell as a primary serving cell and at least a second cell as a secondary serving cell to a mobile device of the wireless communication system, including the second cell in a list for secondary serving cell configuration release in a message for changing the primary serving cell to the second cell, and transmitting the message to the mobile device to release secondary serving cell configuration of the second cell.

### CROSS REFERENCE TO RELATED APPLICATIONS

This application claims the benefit of U.S. Provisional Application No. 61/409,983, filed on Nov. 4, 2010 and entitled “Method and Apparatus for changing PCell in a wireless communication system” and No. 61/409,637, filed on Nov. 3, 2010 and entitled “Method and Apparatus for handling PCell change in a wireless communication system”, the contents of which are incorporated herein in their entirety.

### BACKGROUND OF THE INVENTION

1. Field of the Invention

The application relates to a method utilized in a wireless communication system, and more particularly, to a method of handling primary serving cell change in a wireless communication system and a related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

Toward advanced high-speed wireless communication system, such as transmitting data in a higher peak data rate, LTE-Advanced system is standardized by the 3rd Generation Partnership Project (3GPP) as an enhancement of LTE system. LTE-Advanced system targets faster switching between power states, improves performance at the cell edge, and includes subjects, such as bandwidth extension, coordinated multipoint transmission/reception (COMP), uplink multiple input multiple output (MIMO), etc.

For bandwidth extension, carrier aggregation (CA) is introduced to the LTE-Advanced system for extension to wider bandwidth, where two or more component carriers are aggregated, for supporting wider transmission bandwidths (for example up to 100 MHz) and for spectrum aggregation. According to carrier aggregation capability, multiple component carriers are aggregated into overall wider bandwidth, where the UE can establish multiple links corresponding to the multiple (downlink and uplink) component carriers for simultaneously receiving and transmitting.

In carrier aggregation, the UE only has one RRC connection with the network. At RRC connection establishment/re-establishment/handover, one serving cell provides the NAS mobility information, and at RRC connection re-establishment/handover, one serving cell provides the security input. This cell is referred to as a Primary serving cell (PCell). In the downlink, the carrier corresponding to the PCell is the Downlink Primary Component Carrier (DL PCC) while in the uplink it is the Uplink Primary Component Carrier (UL PCC). In addition, cells other than the PCell are named secondary serving cell (SCell).

In addition, the UE may receive an RRCConnectionReconfiguration message including mobilityControlInfo (i.e. handover) from the network, and handover from a first cell (as PCell) to a second cell (as SCell). After the handover, the second cell becomes the PCell. Note that, if the received RRCConnectionReconfiguration message includes the sCellToAddModList, the UE performs SCell addition or modification, and adds the SCell (e.g. the first cell) to the UE configuration. If the received RRCConnectionReconfiguration message includes the sCellToReleaseModList, the UE performs SCell release, and removes the SCell (e.g. the second cell) from the UE configuration.

According to 3GPP specification TS 36.331, sCellToAddModList information element (IE) and sCellToReleaseModList IE of the RRCConnectionReconfiguration message is optionally present and is mandatory present only upon SCell addition/release. This may cause the following issues. In the first issue, a UE is configured with a PCell (Cell 1) and a SCell (Cell 2) by a network. Therefore, the UE has a SCell configuration of the Cell2. The network changes Cell 2 to be the PCell by sending a RRCConnectionReconfiguration message including mobilityControlInfo (i.e. handover) indicating the Cell 2, to the UE. The RRCConnectionReconfiguration message may not include sCellToAddModListand sCellToReleaseList, and thereby the UE does not add or release any SCell. Hence, the Cell 2 is the PCell but still in the SCell configuration of the UE after PCell change. It is not clearly specified whether a cell (e.g. the Cell 2) can be simultaneous in PCell configuration and SCell configuration. However, the network may determine that the Cell 2 is the PCell, whereas the UE may determine that the Cell 2 is the SCell, causing inconsistent UE configuration.

In the second issue, it is not clearly specified in LTE-Advanced system whether the Cell 1 (previous PCell) becomes a SCell or not due to the RRCConnectionReconfiguration message. More specifically, whether the Cell 1 should be released (i.e. the UE is disconnected from the Cell 1) or added to the SCell configuration of the UE is never concerned. Thus, the UE does not know how to hand the Cell 1 after PCell change. The UE and E-UTRAN may have different SCell configurations. For example, the UE considers the Cell 1 as a SCell but the E-UTRAN does not. This causes that the UE unnecessarily maintains Cell 1 configuration in the SCell configuration and unnecessarily receives signal from the Cell 1.

### SUMMARY OF THE INVENTION

The application discloses a method of handling primary serving cell to secondary serving cell change in a wireless communication system in order to solve the abovementioned problem.

A method of handling primary serving cell change for a network in a wireless communication system is disclosed. The method comprises configuring a first cell as a primary serving cell and at least a second cell as a secondary serving cell to a mobile device of the wireless communication system, including the second cell in a list for secondary serving cell configuration release in a message for changing the primary serving cell to the second cell, and transmitting the message to the mobile device to release secondary serving cell configuration of the second cell.

A method of handling primary serving cell change for a mobile device in a wireless communication system is disclosed. The method comprises being configured a first cell as a primary serving cell and at least a second cell as a secondary serving cell by a network of the wireless communication system, receiving a message for configuring the second cell to be the primary serving cell from the network, wherein the message does not include the first cell in a list for secondary serving cell configuration addition, and automatically configuring the first cell to be the secondary serving cell.

A method of handling primary serving cell change for a network in a wireless communication system is disclosed. The method comprises configuring a first cell as a primary serving cell and at least a second cell as a secondary serving cell to a mobile device of the wireless communication system, and including the first cell in a list, for secondary serving cell configuration addition, in a message for configuring the second cell to be the primary serving cell, and transmitting the message to the mobile device to configure the first cell to be the secondary serving cell.

A method of handling primary serving cell change for a mobile device in a wireless communication system is disclosed. The method comprises being configured a first cell as a primary serving cell and at least a second cell as a secondary serving cell by a network of the wireless communication system, receiving a message for configuring the second cell to be the primary serving cell from the network, wherein the message does not include the first cell in a list for secondary serving cell configuration release, and automatically releasing the first cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an exemplary wireless communication system.

FIG. 2 illustrates a schematic diagram of an exemplary communication device.

FIG. 3 illustrates a schematic diagram of communication protocol layers for an exemplary communication system.

FIGS. 4-7 are flowcharts of exemplary processes.

### DETAILED DESCRIPTION

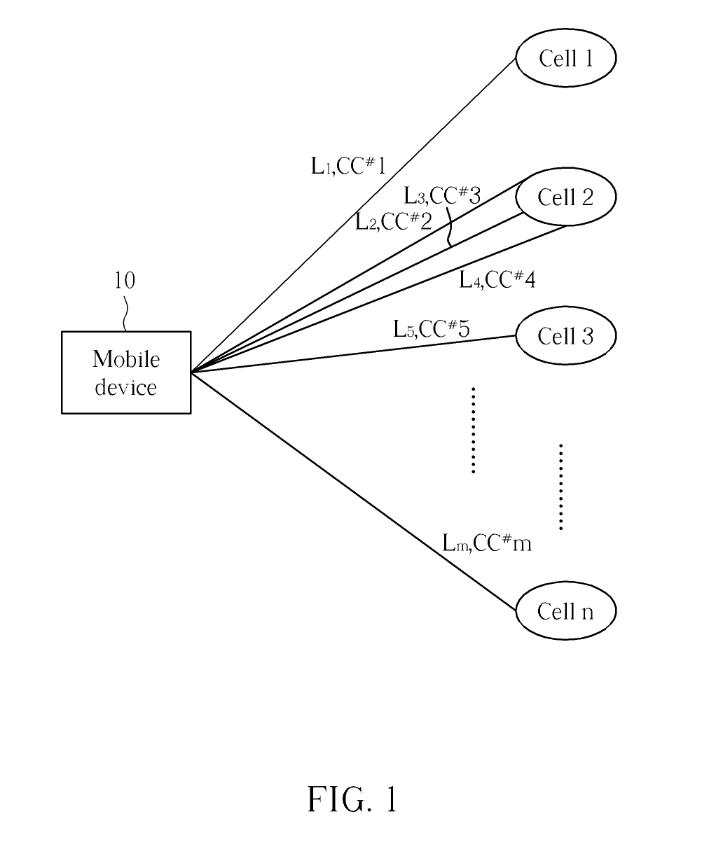

Please refer to FIG. 1, which illustrates a schematic diagram of a wireless communication system featuring multiple connections between a mobile device 10 and cells Cell 1-n. The wireless communication system may be a LTE-Advanced system (i.e. an evolved universal terrestrial radio access network (E-UTRAN)) or any other similar network system. The mobile device 10 can operate with carrier aggregation. In FIG. 1, the mobile device 10 communicates with the cells Cell 1-n through radio links L₁-Lₘ that correspond to component carriers cc#1-cc#m configured in the mobile device 10 respectively. Each of the component carriers cc#1-cc#m corresponds to a radio frequency (RF) channel whose bandwidth may be varied according to different communication systems. In addition, the mobile device 10 is referred as a user equipment (UE) or a mobile station (MS), and can be a device such as a mobile phone, a computer system, etc.

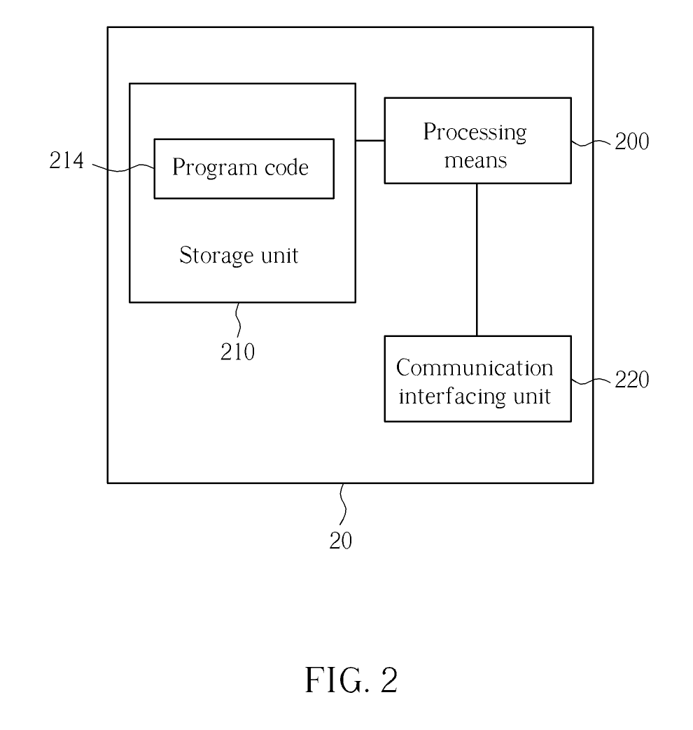

FIG. 2 illustrates a schematic diagram of an exemplary communication device 20. The communication device 20 can be the mobile device shown in FIG. 1 or a network (e.g. the E-UTRAN), but is not limited herein. The communication device 20 may include a processing means 200 such as a microprocessor or Application Specific Integrated Circuit (ASIC), a storage unit 210 and a communication interfacing unit 220. The storage unit 210 may be any data storage device that can store program code 214, for access by the processing means 200. Examples of the storage unit 210 include but are not limited to a subscriber identity module (SIM), read-only memory (ROM), flash memory, random-access memory (RAM), CD-ROMs, magnetic tape, hard disk, and optical data storage device. The communication interfacing unit 220 is preferably a radio transceiver and can exchange wireless signals with the network according to processing results of the processing means 200.

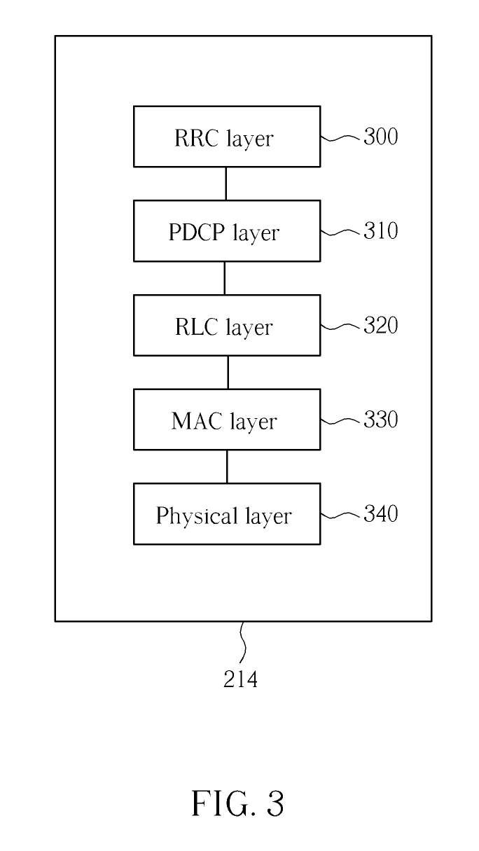

Please refer to FIG. 3, which illustrates a schematic diagram of communication protocol layers for the LTE-Advanced system. The behaviors of some of the protocol layers may be defined in the program code 214 and executed by the processing means 200. The protocol layers from top to bottom are a radio resource control (RRC) layer 300, a packet data convergence protocol (PDCP) layer 310, a radio link control (RLC) layer 320, a medium access control (MAC) layer 330 and a physical (PHY) layer 340. The RRC layer 330 is responsible for measurement configuration, mobility control, radio resource configuration, etc.

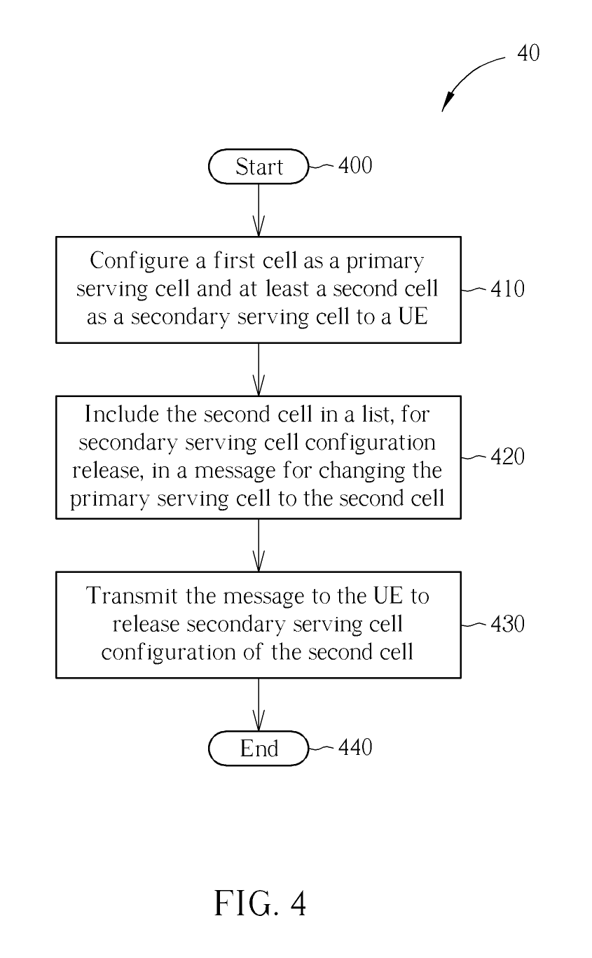

Please refer to FIG. 4, which illustrates a flowchart of an exemplary process 40. The process 40 is utilized in a network for handling primary serving cell change. The process 40 can be compiled into the program code 214 and includes the following steps:

Step 400: Start.

Step 410: Configure a first cell as a primary serving cell and at least a second cell as a secondary serving cell to a UE.

Step 420: Include the second cell in a list, for secondary serving cell configuration release, in a message for changing the primary serving cell to the second cell.

Step 430: Transmit the message to the UE to release secondary serving cell configuration of the second cell.

Step 440: End.

According to the process 40, the UE is configured by the network with a first cell as primary serving cell (PCell) and at least a second cell as a secondary serving cell (SCell). If the network determines to change the PCell to the second cell, the network always includes the second cell in the list for SCell configuration release (e.g. a sCellToReleaseList) in a message (e.g. a RRCConnectionReconfiguration message) to release the SCell configuration of the second cell and transmits the message to the UE. In a word, the network releases SCell configuration of the second cell in explicit signaling, so as to avoid that the second cell in the PCell configuration and SCell configuration simultaneously.

Take an example based on the process 40. Referring back to the FIG. 1, assume the Cell 1 is configured as the PCell and the Cell 2 is the SCell for the UE. If the network changes the PCell to the Cell 2 with the RRCConnectionReconfiguration message, the network includes the Cell 2 in the sCellToReleaseList in the RRCConnectionReconfiguration message. In detail, the RRCConnectionReconfiguration message may include mobilityControlInfo (i.e. handover) indicating the Cell 2. Therefore, when the UE receives the RRCConnectionReconfiguration message from the network, the UE handovers to the Cell 2 and thereby changes the PCell to the Cell 2. In addition, the UE releases SCell configuration of the Cell 2 according to the sCellToReleaseList in the RRCConnectionReconfiguration message. Thus, the UE does not determine that the Cell 2 as the SCell, so as to avoid the Cell 2 is the PCell but still the SCell in the UE configuration.

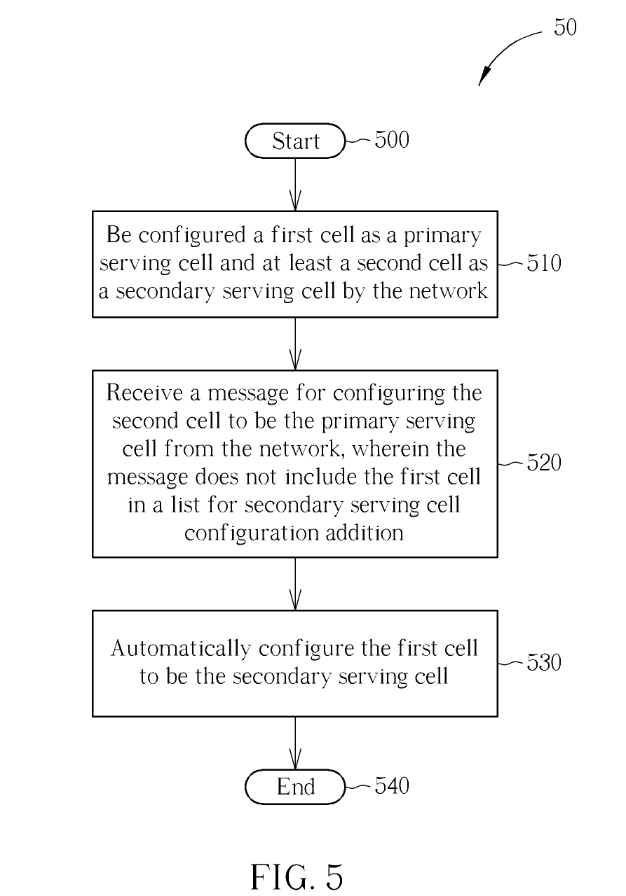

Please refer to FIG. 5, which illustrates a flowchart of an exemplary process 50. The process 50 is utilized in a UE for handling primary serving cell change. The process 50 can be compiled into the program code 214 and includes the following steps:

Step 500: Start.

Step 510: Be configured a first cell as a primary serving cell and at least a second cell as a secondary serving cell by the network.

Step 520: Receive a message for configuring the second cell to be the primary serving cell from the network, wherein the message does not include the first cell in a list for secondary serving cell configuration addition.

Step 530: Automatically configure the first cell to be the secondary serving cell.

Step 540: End.

According to the process 50, the UE is configured with a first cell as the PCell and at least a second cell as the SCell. If the UE receives a message (e.g. RRCConnectionReconfiguration message) which configures the second cell to be the PCell and does not include the first cell in the list for SCell configuration addition (e.g. sCellToAddModList), the UE configures that the first cell is the SCell. In other words, the first cell automatically becomes the SCell after the PCell change. Based on the process 50, whether the first cell becomes the SCell after the PCell change is clearly defined.

Take an example based on the process 50. Referring back to the FIG. 1, assume that the Cell 1 is configured as the PCell and the Cell 2 is the SCell for the UE, and the network changes the PCell to the Cell 2 with the RRCConnectionReconfiguration message, wherein the RRCConnectionReconfiguration message does not includes the Cell 1 in the sCellToAddModList or does not include the sCellToAddModList. In detail, the RRCConnectionReconfiguration message may include mobilityControlInfo (i.e. handover) indicating the Cell 2. Therefore, when the UE receives the RRCConnectionReconfiguration message from the network, the UE handovers to the Cell 2 and thereby changes the PCell to the Cell 2. In addition, the UE automatically configures the Cell 1 to be SCell. In other words, The RRCConnectionReconfiguration message is implicitly used to perform swap of the PCell and the SCell.

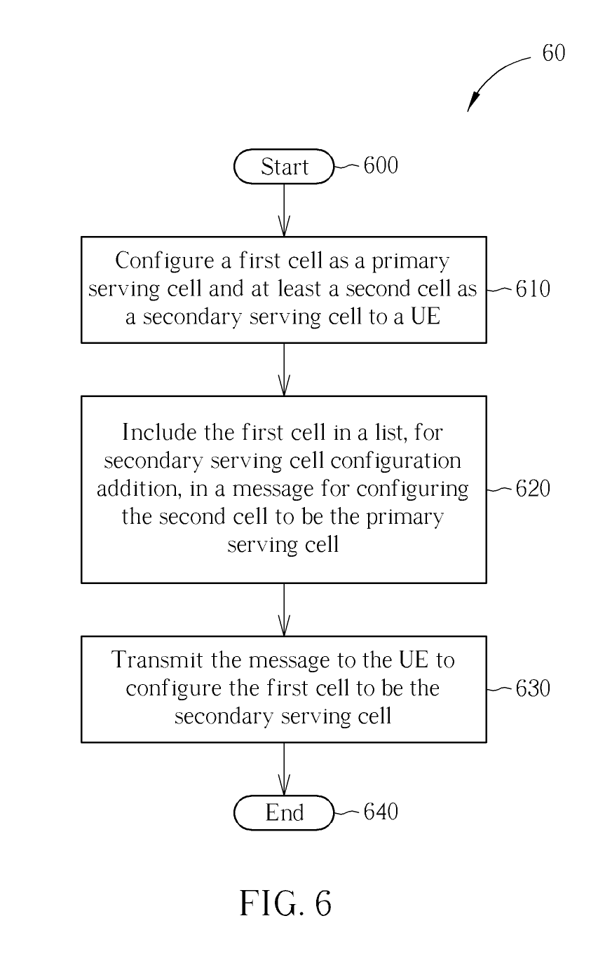

Please refer to FIG. 6, which illustrates a flowchart of an exemplary process 60. The process 60 is utilized in a network for handling primary serving cell change. The process 60 can be compiled into the program code 214 and includes the following steps:

Step 600: Start.

Step 610: Configure a first cell as a primary serving cell and at least a second cell as a secondary serving cell to a UE.

Step 620: Include the first cell in a list, for secondary serving cell configuration addition, in a message for configuring the second cell to be the primary serving cell.

Step 630: Transmit the message to the UE to configure the first cell to be the secondary serving cell.

Step 640: End.

According to the process 60, the UE is configured by the network with a first cell as the PCell and at least a second cell as the SCell. If the network wants to swap the PCell with SCell in the RRCConnectionReconfiguration message, the network always includes the first cell in the sCellToAddModList in RRCConnectionReconfiguration message to explicitly configure the first cell to be the SCell. Based on the process 60, whether the first cell becomes the SCell after the PCell change is clearly defined.

Take an example based on the process 60. Referring back to the FIG. 1, assume the Cell 1 is configured as the PCell and the Cell 2 is the SCell for the UE. If the network changes the PCell to the Cell 2 with the RRCConnectionReconfiguration message, the network includes the Cell 1 in the sCellToAddModList in the RRCConnectionReconfiguration message. In detail, the RRCConnectionReconfiguration message may include mobilityControlInfo (i.e. handover) indicating the Cell 2. Therefore, when the UE receives the RRCConnectionReconfiguration message from the network, the UE handovers to the Cell 2 and thereby changes the PCell to the Cell 2. In addition, the UE configures the Cell 1 to be the SCell according to the sCellToAddModList in the RRCConnectionReconfiguration message. Thus, the Cell 1 becomes the SCell after the PCell change.

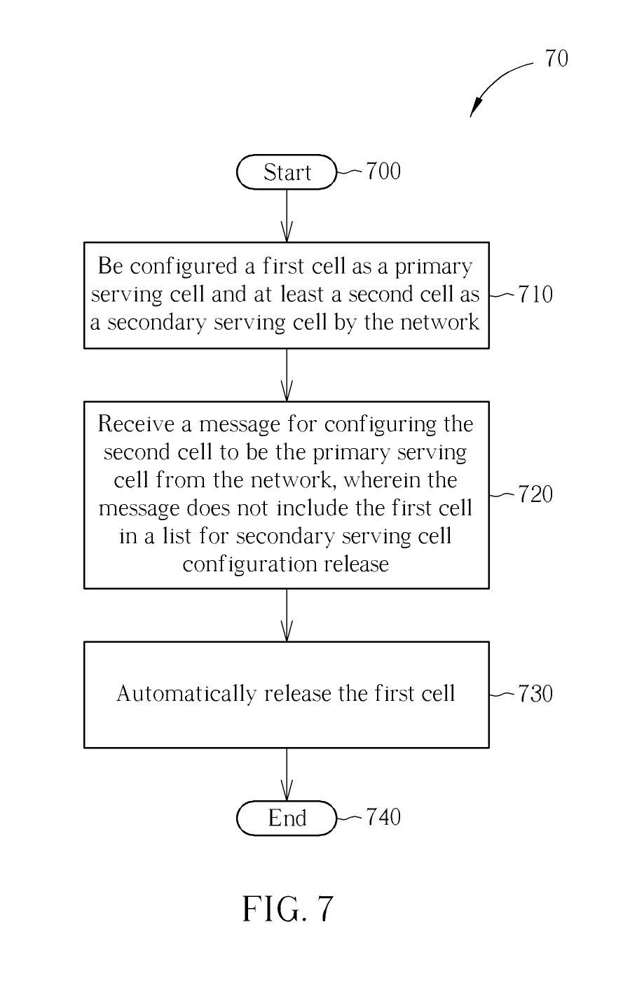

Please refer to FIG. 7, which illustrates a flowchart of an exemplary process 70. The process 70 is utilized in a UE for handling primary serving cell change. The process 70 can be compiled into the program code 214 and includes the following steps:

Step 700: Start.

Step 710: Be configured a first cell as a primary serving cell and at least a second cell as a secondary serving cell by the network.

Step 720: Receive a message for configuring the second cell to be the primary serving cell from the network, wherein the message does not include the first cell in a list for secondary serving cell configuration release.

Step 730: Automatically release the first cell.

Step 740: End.

According to the process 70, the UE is configured with a first cell as the PCell and at least a second cell as the SCell. If the UE receives a message (e.g. RRCConnectionReconfiguration message) which configures the second cell to be the PCell and does not include the first cell in sCellToReleaseList, the UE releases the first cell. In other words, the first cell does not automatically become the SCell. Based on the process 70, whether the first cell becomes the SCell after the PCell change is clearly defined.

Take an example based on the process 70. Referring back to the FIG. 1, assume that the Cell 1 is configured as the PCell and the Cell 2 is the SCell for the UE, and the network changes the PCell to the Cell 2 with the RRCConnectionReconfiguration message, wherein the RRCConnectionReconfiguration message does not includes the Cell 1 in the sCellToReleaseList or does not include the sCellToReleaseList. In detail, the RRCConnectionReconfiguration message may include mobilityControlInfo (i.e. handover) indicating the Cell 2. Therefore, when the UE receives the RRCConnectionReconfiguration message from the network, the UE handovers to the Cell 2 and thereby changes the PCell to the Cell 2. In addition, the UE releases the Cell 1 (i.e. the UE is disconnected from the Cell 1). Thus, after the PCell change, the Cell 1 does not become the SCell.

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, the present invention provides methods for handling PCell change, to clearly define that the UE releases the SCell configuration of a cell after the cell is changed from the SCell to the PCell. In addition, the present invention clearly specified whether a cell becomes the SCell or not after the PCell change.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling primary serving cell change for a network in a wireless communication system, the method comprising:
configuring a first cell as a primary serving cell and at least a second cell as a secondary serving cell to a mobile device of the wireless communication system;
including the second cell in a list, for secondary serving cell configuration release, in a message for changing the primary serving cell to the second cell; and
transmitting the message to the mobile device to release secondary serving cell configuration of the second cell.

2. The method of claim 1, wherein the message is a RRCConnectionReconfiguration message including mobility control information indicating the second cell; and the list is a sCellToReleaseList.

3. A method of handling primary serving cell change for a mobile device in a wireless communication system, the method comprising:
being configured a first cell as a primary serving cell and at least a second cell as a secondary serving cell by a network of the wireless communication system;
receiving a message for configuring the second cell to be the primary serving cell from the network, wherein the message does not include the first cell in a list for secondary serving cell configuration addition; and
automatically configuring the first cell to be the secondary serving cell.

4. The method of claim 3, wherein the message is a RRCConnectionReconfiguration message including mobility control information indicating the second cell; and the list is a sCellToAddModList.

5. The method of claim 3, wherein the message does not include the first cell in the list for secondary serving cell configuration addition includes that the message does not include the list for secondary serving cell configuration addition.

6. A method of handling primary serving cell change for a mobile device in a wireless communication system, the method comprising:
being configured a first cell as a primary serving cell and at least a second cell as a secondary serving cell by a network of the wireless communication system;
receiving a message for configuring the second cell to be the primary serving cell from the network, wherein the message does not include the first cell in a list for secondary serving cell configuration release; and
automatically releasing the first cell.

7. The method of claim 6, wherein the message is a RRCConnectionReconfiguration message including mobility control information indicating the second cell; and the list is a sCellToReleaseList.

8. The method of claim 6, wherein the message does not include the first cell in the list for secondary serving cell configuration release comprises that the message does not include the list.
